(19) United States
(12) Patent Application Publication
(10) Pub. No.: US 2022/0311201 A1
(43) Pub. Date: Sep. 29, 2022

(54) Waveguide amplifier

(71) Applicant: Aalto University Foundation sr, Aalto (FI)

(72) Inventors: Zhipei Sun, Aalto (FI); John Rönn, Aalto (FI)

(21) Appl. No.: 17/638,887

(22) PCT Filed: Aug. 31, 2020
(86) PCT No.: PCT/FI2020/050562

§ 371 Date: Feb. 28, 2022

(30) Foreign Application Priority Data
Aug. 30, 2019 (FI) 20195714

(51) Int. Cl. H01S 3/063; H01S 3/16

(52) U.S. Cl. CPC H01S 3/0637; H01S 3/1608; H01S 3/1636

(57) ABSTRACT

The present invention concerns a waveguide amplifier and a waveguide amplifier device comprising it. In addition, the invention concerns a method for producing such waveguide amplifier. The invention especially relates to erbium doped waveguide amplifiers having a controlled doping concentration.

### BACKGROUND OF THE INVENTION

### Field of the Invention

The present invention concerns a waveguide amplifier and a waveguide amplifier device comprising it, as well as a method producing the same. In particular, the present invention concerns a rare-earth material, especially erbium, doped waveguide amplifier.

### Description of Related Art

Modern information society is based on a physical infrastructure where electronics plays an essential role. Apart from low-loss optical fiber transmission channels, information processing occurs via electronic routing and switching elements. Data centers, in particular, have a very large number of electronic equipment and boards. Optical interconnects, in the form of receivers, are seeing their development accelerate, particularly to cope with the increasing information bit rates and substantial power consumption in data centers. The reason for this is simple: the lower the power consumption, the lower the cost per bit. For this purpose, reliable large-scale manufacturing capabilities are ultimately desired as the deployment of photonics enabling functionalities, such as Wavelength Division Multiplexing (WDM), is taking place chip-scale. Photonic integration, on its side, has made a considerable progress over the recent years.

However, among its main disadvantages, the indirect nature of silicon's band structure, which prevents it from emitting and amplifying optical signs, is the most critical. This has led to severe challenges in developing solutions for on-chip optical amplifications without having to resort to energy expensive optical/electronic conversions. In this context, the hetero-integration of III/V semiconductor amplifiers on silicon, as developed recently, is a possible answer but still remains too complex and expensive in terms of fabrication and all-monolithic integration. On the other hand, a much simpler and in-expensive solution has been proposed. It consists of reproducing the operation principle of all-optical erbium-doped fiber amplifier (EDFA) into the form of erbium-doped integrated waveguide amplifier (EDWA). Indeed, such devices have been recently explored to develop the essential active functionalities on the silicon photonic platform where cost-effective mass production methods for CMOS-compatible amplifier and laser devices are desired.

However, the transition from EDFAs to fully integrated silicon-compatible EDWAs is not trivial. The greatest challenge comes from the typical active waveguide lengths that usually scale in hundreds of μm in photonic integrated circuits instead of several tens of meters for optical fibers. Moreover, light propagation losses in sub-μm² (or even narrower) cross-section waveguides is usually expressed in dB/cm while fiber losses are on the order of 0.2 dB/km at 1.55 μm. The dramatic reduction in the amplification lengths combined with the strong increase in optical losses imply that tremendous efforts need to be made not only on the active material quality, but also for the optimization of the waveguide passive losses.

These challenges are, in fact, anything but obvious and constitute to difficult issues to resolve. Recently, erbium-doped integrated waveguide devices have been extensively studied as a CMOS-compatible and inexpensive solution for optical amplification and lasing on the silicon photonic platform. The Er-ion doping level is increased to compensate the considerable waveguide losses. Yet, the Er-doping can be increased up to a certain limit as the high Er-incorporation introduces unwanted transitions and quenching of active ions within the gain medium, which ultimately lead to diminishing returns in the amplifier performance. To optimize the performance of erbium-based integrated amplifier devices, various host materials and different fabrication methods have been studied to achieve high Er-incorporation with little to no quenched Er-ions inside different compounds.

For example, US-publication 2003/0174391 A1 describes a waveguide amplifier having a rare-earth doped core, wherein the portion of the rare-earth ion is involved in unsaturable absorption, wherein a distributed absorption of signal light can be created along a length of the amplifier. U.S. Pat. No. 7,469,558 discloses an as-deposited waveguide structure that is formed by a vapor deposition process. The core layer of the structure can be doped with Erbium to achieve higher refractive index.

Additionally, unique waveguide geometries have also been proposed to maximize the interaction of the guided beams with the active layer. However, erbium-doped waveguide technology still remains relatively immature when it comes to the production of competitive building blocks for the silicon photonics industry. Therefore, further progress is critical in this field to answer the industry's demand for infrared emitters that are not only CMOS-compatible and efficient, but also stable and scalable in terms of large volume production. Thus, further improvements, such as higher gain, scalable fabrication process and lower deposition temperatures need to be pursued for ultimate silicon photonic circuit compatibility.

### SUMMARY OF THE INVENTION

The present invention aims at solving at least some of the problems of the prior art.

It is an object of the present invention to provide an improved waveguide amplifier, especially a strip waveguide amplifier.

It is another object of the present invention to provide a waveguide amplifier device.

It is a third object of the present invention to provide a method for producing waveguide amplifiers.

Thus, the present invention relates to a cost-effective waveguide amplifier on silicon, especially to a rare-earth material-doped waveguide amplifier that can preferably be fabricated with a single active layer deposition process. In particular, the present invention relates to an optical erbium-doped waveguide amplifier (i.e. EDWA), the doping concentration of which is controlled both in atom and in nanoscale.

In particular, the present invention relates to combination of an atomic layer deposition (ALD), especially a low-temperature ALD, process for strongly-doped erbium-alumina (Er:Al₂O₃) and fully industrial 300 mm silicon nitride (Si₃N₄) on silicon photonic platform to provide on-chip optical gain with cost-effective methods.

The waveguide amplifier of the present invention comprises a planar silicon substrate, layer of optical quality silicon dioxide, a core and an upper cladding layer formed uniformly and conformally to cover the core and the silicon dioxide layer. The upper cladding layer contains one or more layers being doped with a rare-earth material, wherein the doping concentration of the rare-earth material can be controlled, preferably progressively controlled, within the perpendicular plane of the nanometer scale and within the planar and perpendicular plane of the layer in atomic scale. In one embodiment, there is formed a concentration gradient of the rare-earth material both in a plane in parallel to the plane of the substrate and in a plane perpendicular to the plane of the substrate. Typically, the concentration of the rare-earth material decreases gradually (or progressively) in perpendicular direction away from the plane of the substrate.

According to one embodiment, the waveguide amplifier further comprises a top cladding layer formed on the upper cladding layer.

The present invention also relates to the method of producing such a waveguide amplifier. The method comprises the steps of depositing the different layers on top of each other on suitable methods. In the deposition of the upper cladding layer, atomic layer deposition (ALD) is preferably utilized.

It has been surprisingly found that by combining atomic layer deposition and a suitable silicon/silicon nitride core on silicon photonic platform a waveguide amplifier can be provided which exhibits improved properties enabling controlling of the rare-earth material distribution in the upper cladding layer.

The method of the present invention, according to a preferred embodiment, is based on the idea of controlling the rare-earth material doping concentration in the active layer by using ALD.

The present invention presents a simple yet exceptional configuration that combines atomic layer deposition and fully industrial silicon or silicon nitride on silicon photonic platform to form cost-effective waveguide amplifiers on silicon preferably with a single active layer deposition.

In addition, the present invention relates to a waveguide amplifier device comprising multiple waveguides.

More specifically, the present invention is characterized by what is stated in the independent claims. Some specific embodiments are defined in the dependent claims.

Several advantages are reached using the present invention. First, the present invention is the first demonstration of a silicon-integrated waveguide amplifier that can be fabricated with a single active layer deposition process. Second, the present invention is the first demonstration of net on-chip optical gain on silicon-based strip waveguides, but also the first demonstration of net on-chip optical gain generated over entire waveguide channels that include input and output fiber-to-waveguide couplers. In particular the present invention enables achieving net optical gain in a compact footprint.

The present invention shows tremendous progress in developing cost-effective active building blocks on the silicon photonic platform.

The waveguide amplifier of the present invention is suitable to be used as an infrared emitter that is both CMOS-compatible and efficient at the same time. The amplifier of the present invention is also very stable and it is easily scalable in terms of large volume production.

### BRIEF DESCRIPTION OF THE DRAWINGS

FIG. 1 shows a schematic of the waveguide amplifier device layout and cross-sectional view of the waveguide amplifier according to one embodiment of the present invention.

FIG. 2 shows an atomic scale illustration of the upper cladding layer according to one embodiment of the present invention.

FIG. 3 shows transmission characterization of the Er:Al₂O₃—Si₃N₄ waveguide amplifiers according to one embodiment of the present invention.

FIG. 4 shows signal enhancement characterization of the Er:Al₂O₃—Si₃N₄ waveguide amplifiers according to one embodiment of the present invention.

FIG. 5 shows photoluminescence measurement results of various erbium-alumina active layers according to one embodiment of the present invention.

FIG. 6 shows gain simulation results of various multilayer waveguide amplifiers according to one embodiment of the present invention.

### EMBODIMENTS

The present invention relates to a rare-earth material doped waveguide amplifier, especially to an erbium-doped waveguide amplifier (EDWA). Thus, according to a preferred embodiment the doped rare-earth material or metal is erbium.

According to another embodiment the waveguide can also be doped with another rare-earth material, preferably with a rare-earth material belonging to the group of lanthanides. Thus, generally, the rare-earth material suitably comprises a rare-earth element such as erbium, tellurium, thulium, holmium or ytterbium and combinations thereof.

In one embodiment, the rare-earth material comprises a metal compound, such as an oxide, for example erbium oxide.

The waveguide of the present invention demonstrates net on-chip optical gain especially at a wavelength of 1533 nm.

The waveguide amplifier of the present invention comprises a planar silicon substrate, optical silicon dioxide layer, a core and an upper cladding layer containing one or more layers being doped with a rare-earth material, and optionally a top cladding layer.

The optical silicon dioxide (silica) layer is formed on the silicon substrate and the core is formed on the silica layer, respectively. The core is preferably deposited in the middle of the silica layer, wherein relation of the width of the core and the silica layer is preferably in the range of 1:2 to 1:6, more preferably in the range 1:3 to 1:5, for example 1:4. The upper cladding layer is formed to cover the core and the silica layer. Doping concentration of the rare-earth material is controlled in the upper cladding layer, both within the perpendicular plane of the layer in nanometer scale and within the planar and perpendicular plane of the layer in atomic scale.

According to one embodiment, the thickness of the silica layer is in the range of 0.5 to 2.5 μm, preferably in the range of 1.0 to 2.0 μm, suitably in the range of 1.2 to 1.6 μm, such as 1.4 μm.

According to one embodiment the core of the waveguide amplifier is silicon or silicon nitride, preferably silicon nitride (Si₃N₄). According to one embodiment, the thickness of the core layer is in the range of 200 to 1000 nm, preferably in the range of 400 to 800 nm, suitably in the range of 500 to 700 nm, such as 600 nm.

According to one embodiment, the thickness of the upper cladding layer is 100 to 200 nm, preferably 130 to 180 nm, most preferably 140 to 160 nm, for example 150 nm. The upper cladding layer comprises 1 or more layers of the cladding material. According to one embodiment the rare-earth material doping concentration is 0.5 to 5 at. %, preferably 1.0 to 4.0 at. %, more preferably 1.11 to 3.88 at. %, calculated from the number of atoms in the upper cladding layer. Preferably, the upper cladding layer consists of an erbium-doped aluminum oxide.

According to one embodiment the upper cladding layer is fabricated with a single active layer deposition process. According to another embodiment the upper cladding layer comprises multiple spatially engineered rare-earth material-doped gain layers.

According to a preferred embodiment, the waveguide amplifier of the present invention comprises silicon nitride as a core and erbium as a doped rare-earth material. Thus, according to a preferred embodiment the method of the present invention provides Er:Al₂O₃—Si₃N₄ waveguide amplifiers, i.e. erbium doped waveguide amplifiers.

Thus, according to one embodiment the upper cladding layer material is a strongly doped erbium-alumina. An atomic scale illustration of the upper cladding layer comprising erbium-alumina according to one embodiment of the present invention is presented in FIG. 2, wherein the controlled distribution of erbium (the biggest atoms) in the structure can be seen.

According to one embodiment the top cladding layer material is a resist material, for example poly(methyl methacrylate) (PMMA). The top cladding layer enables a vertically-quasi-symmetric mode confinement for the waveguide amplifier.

Preferably, the waveguide amplifier of the present invention is a strip waveguide amplifier. Producing a strip waveguide amplifier by utilizing ALD for the deposition of the upper cladding layer provides a waveguide amplifier wherein the optical losses are minimized.

The present invention also relates to a method of producing the waveguide amplifier of the present invention. The method comprises the step of depositing the different layers on top of each other. The silica layer and the core are deposited on top of each other on silicon substrate and then covered with the upper cladding layer, and optionally with the top cladding layer.

According to one embodiment, the method comprises depositing an optical quality silicon dioxide (silica) layer on a planar silicon substrate, depositing a core on the silica layer and covering the silica layer and the core with an upper cladding layer. The upper cladding layer contains one or more layers being doped with a rear-earth material, wherein the doping concentration of the rare-earth material is controlled within the perpendicular plane of the layer in nanometer scale, and within the planar and perpendicular plane of the layer in atomic scale.

According to one embodiment the first step of producing the waveguide amplifier of the present invention comprises depositing optical-quality silicon dioxide on silicon substrate, preferably by a low-pressure chemical vapour deposition.

According to one embodiment, the next step of producing the waveguide amplifier of the present invention comprises depositing silicon or silicon nitride layer, i.e. the core, on the silica layer, preferably by a plasma-enhanced chemical vapour deposition.

According to a preferred embodiment, the depositions of silicon dioxide and core, preferably, silicon nitride, layers are followed by a deep-ultraviolet lithography, and preferably by a reactive ion etching, wherein passive waveguide channels are obtained.

Typically, the deep-ultraviolet lithography is performed with wavelength of 200 to 300 nm, for example 248 nm.

The next step of the present method comprises covering, i.e. coating, of the formed waveguide channels with the upper cladding layer, preferably with erbium-alumina (Er:Al₂O₃)layer/layers.

According to a preferred embodiment, the coating step comprises sequentially depositing erbium oxide (Er₂O₃) and aluminum oxide (Al₂O₃) onto the surfaces of the waveguides with thermal ALD (for example Beneq TFS-500). Preferably, the erbium oxide is grown by using Er(thd)₃ and ozone precursors, whereas the aluminum oxide is grown by using trimethylaluminun (TMA) and water precursors.

The ALD method used in the present invention enables controlling of the doping concentration of the rare-earth material in the upper cladding layer, both within the perpendicular plane of the layer in nanometer scale and within the planar and perpendicular plane of the layer in atomic scale. According to a preferred embodiment the doping concentration of the rare-earth material in the upper cladding layer is changed, in particular decreased, for example progressively changed, preferably progressively decreased, perpendicularly to the plane of the layer, i.e. the doping concentration decreases in the perpendicular direction from the core and silicon nitride layer.

Different film compositions can be provided by varying the relative Er₂O₃/Al₂O₃ supercycle sequence (i.e. the relation of Er₂O₃ and Al₂O₃ cycles) and number of layers for the process. Examples 1 and 2 describe properties and preparation for different atomic-layer-deposited erbium-alumina active layers having a total of 1 to 5 layers.

In one embodiment, the active layer comprises more than 1 and up to 20 ALD layers, for example 2 to 10 ALD layers.

In one embodiment of the present invention, a low-temperature atomic layer deposition (ALD) process for strongly-doped erbium-alumina (Er:Aₗ₂O₃) has been combined with fully industrial 300 mm silicon nitride (Si₃N₄) on silicon photonic platform to provide on-chip optical gain with cost-effective methods.

According to a preferred embodiment, the ALD is performed at a temperature of 250 to 350° C., preferably at 280 to 320° C., for example at 300° C.

According to one embodiment, the waveguide amplifier thus produced can be post-process annealed, preferably at a temperature of about 500 to 1000° C., preferably at about 800° C. for about 10 to 30 minutes, preferably for about 20 minutes, to obtain ultimate performance from the doped active layers.

According to a further embodiment, a top cladding layer, such as layer of polymethyl methacrylate (PMMA)-resist, can be preferably spin-coated onto the waveguide amplifier to achieve vertically-quasi-symmetric mode confinement and to eliminate leaky losses in the waveguides.

The present invention also relates to a waveguide amplifier device. According to one embodiment the waveguide of the present invention is a silicon nitride strip waveguide, which allows a very large density of waveguides, preferably EDWAs, to be fabricated on a single chip.

According to one embodiment, the waveguide amplifier device of the present invention comprises multiple waveguide channels coated with the upper cladding layer. Each waveguide channel contains one single-mode strip waveguide, having for example the width of 400 nm, height of 600 nm and the length of 100 to 2000 μm, followed by a grating coupler, having for example the width of about 15 μm, height of 600 nm, and length of 100 μm, and a multi-mode to single-mode transition taper at the input and output sides of the corresponding channel.

According to another embodiment, the waveguide of the present invention is a slot waveguide.

According to one embodiment the present invention relates a waveguide amplifier comprising a silicon substrate, an optical quality silicon dioxide (silica) layer formed on the substrate, a silicon nitride layer formed on the silica layer, and a rare-earth material doped aluminum oxide layer on the silica and the silicon nitride layers. The rare-earth material doped aluminum oxide layer is deposited by using atomic layer deposition (ALD), wherein the doping concentration of the rare-earth material decreases, in particular progressively decreases, in a perpendicular plane when moving farther from the substrate.

Typically, fiber-to-waveguide coupling occurs via the high-quality input grating coupler. The coupled optical beam is guided to the multi-mode to single-mode transition taper that converts the beam suitable for the single-mode strip waveguide. When combined with the doped active layer, such as erbium alumina layer, the single-mode strip waveguide acts as an integrated waveguide amplifier. Once the beam has transmitted through the single-mode strip waveguide, the beam guiding and conversion process is reversed for efficient out-coupling.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### EXAMPLES

### Example 1

In this example, a waveguide amplifier that combines a silicon nitride strip waveguide and a single Er:Al₂O₃ gain layer is demonstrated. First, optical quality silicon dioxide was deposited on silicon substrate of the device by a low pressure chemical vapor deposition, wherein the silicon dioxide layer had a thickness of 1.4 μm. Next, silicon nitride layer with a thickness of 600 nm was deposited on the silicon dioxide layer by a plasma-enhanced chemical vapor deposition.

Deposition of silicon dioxide and silicon nitride layers was followed by a deep-ultraviolet lithography (248 nm) and reactive ion etching.

The formed waveguide channels, as well as the whole device, were coated with about 150 nm thick layer of erbium-alumina (Er:Al₂O₃) by sequentially depositing erbium oxide (Er₂O₃) and aluminum oxide (Al₂O₃) onto the surface of the waveguide channels with thermal ALD. The erbium oxide was grown by using Er(thd)₃ and ozone precursors, whereas the aluminum oxide was grown by using trimethylaluminum (TMA) and water precursors. The growing temperature was 300° C. There were made four different erbium-alumina depositions with varying erbium-alumina layer sequence to form four different devices with each device containing multiple waveguide amplifier channels.

Such produced devices were post-process annealed at 800° C. for 20 minutes. Finally, a layer of PMMA-resist was spin-coated onto each device to obtain finished waveguide amplifier devices.

Characterization

The cycle sequences and the resulting film compositions of the erbium-alumina active layers used in each device prepared in Example 1 are presented in Table 1. The elemental compositions were measured with energy dispersive X-ray spectroscopy by focusing a high-energy beam (15 keV) of electrons onto each active layer and recording their characteristic X-ray spectra. The layers were found to be slightly oxygen rich with Er-concentration ranging from 1.11 to 3.88 at. %.

TABLE 1
Properties and preparation conditions for the atomic
layer-deposited erbium-alumina active layers

| | | | | | Elemental | | |
|---|---|---|---|---|---|---|---|
| | | | | Thick- | composition | | |
| | Number of cycles | | | ness | (at. %) | | |
| Layer | Er₂O₃ | Al₂O₃ | Total | (nm) | O | Al | Er |
| 1 | 1 | 12 | 125 | 146.6 | 64.26 | 34.63 | 1.11 |
| 2 | 1 | 6 | 250 | 149.8 | 63.53 | 34.49 | 1.98 |
| 3 | 1 | 3 | 500 | 150.6 | 63.28 | 33.64 | 3.08 |
| 4 | 1 | 2 | 750 | 151.1 | 62.92 | 33.20 | 3.88 |

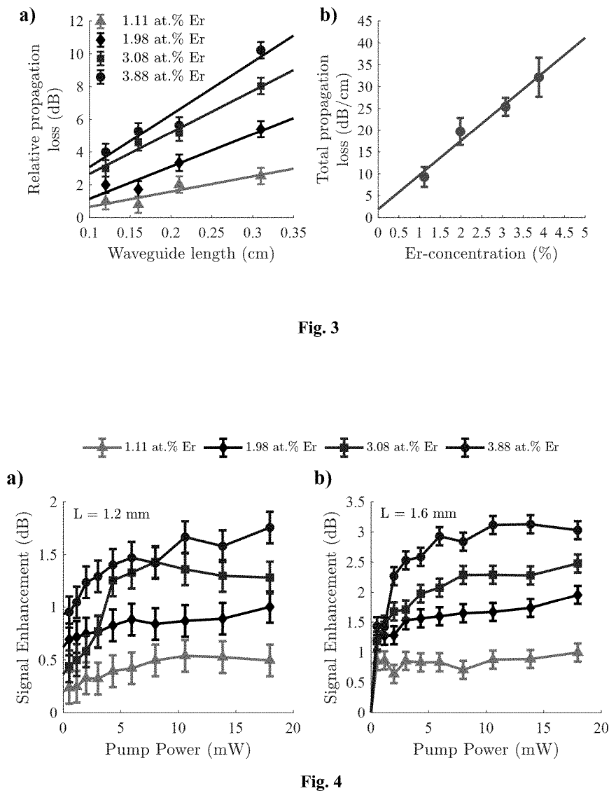

The transmission properties of the fabricated Er:Al₂O₃—Si₃N₄ waveguide amplifiers were studied by coupling only the signal beam into the waveguide channels of each individual device. FIG. 3 presents the relative propagation loss of the signal beam (λ_{c}=1533 nm, Pᵢₙ=100 nW) after having propagated in 1.2, 1.6, 2.1 and 3.1 mm long waveguide amplifiers in the absence of the pump beam. The transmission data is shown for each individual waveguide (i.e. waveguide length and active layer Er-concentration). The total propagation loss (in dB/cm) of each waveguide amplifier set was determined by linear least-squares fitting, as shown by the solid lines in FIG. 3a. The propagation loss values are shown in FIG. 3b as a function of the Er-concentration (solid points). It is worthwhile to note that the evaluated total propagation loss equals to loss occurring in the single-mode waveguides of the corresponding waveguide channels since only the length of the single-mode waveguide varies in our waveguide amplifier design. In both FIGS. 3a and 3b solid points correspond to the experimental measured propagation loss values whereas the solid lines are theoretical linear least-squares fits to the data sets.

The amplification properties for the fabricated Er:Al₂O₃—Si₃N₄ waveguide amplifiers were studied by co-coupling the signal (λ_{c}=1533 nm, Pᵢₙ=1 μW) and pump (λ_{c}=1480 nm, Pᵢₙ=0-18 mW) beams inside the waveguide amplifier channels. The signal enhancement (SE) generated by each waveguide was then measured by varying the launched pump power in progressive steps from 0 to 18 mW. The obtained results are shown in FIGS. 4a and 4b for waveguide amplifier channels with lengths of 1.2 mm and 1.6 mm, respectively. FIGS. 4a and 4b demonstrate that the signal enhancement generated by each waveguide amplifier increased as the erbium concentration in the active layer increased with saturation-like behavior occurring after approximately 5-10 mW pump power was launched into the waveguide channels.

Signal enhancement can be used to calculate a modal gain values for the waveguide amplifiers. The obtained propagation loss (a), signal enhancement (SE) and modal gain (g_{mod}) values are summarized in table 2.

TABLE 2
Measured transmission and amplification properties of the
waveguide amplifiers

| | | SEₘₐₓ | |
|---|---|---|---|
| | | [1.2/1.6 mm] | g_{mod} [1.2/1.6 mm] |
| Layer | aₗₒₜ [1.2/1.6 mm] (dB) | (±0.15 dB) | (dB/cm) |
| 1 | 0.41 ± 0.10/0.78 ± 0.19 | 0.54/1.00 | 1.07 ± 1.50/1.35 ± 1.13 |
| 2 | 0.87 ± 0.14/1.66 ± 0.26 | 1.00/1.96 | 1.10 ± 1.69/1.85 ± 1.27 |
| 3 | 1.11 ± 0.09/2.13 ± 0.17 | 1.43/2.48 | 2.63 ± 1.46/2.20 ± 1.10 |
| 4 | 1.42 ± 0.20/2.70 ± 0.38 | 1.76/3.13 | 2.82 ± 2.07/2.65 ± 1.55 |

Based on the waveguide measurements, all the fabricated waveguide amplifiers exhibit positive net on-chip optical gain when sufficient pump power is launched into the active waveguides. Furthermore, the results demonstrate that the device of the present invention can be easily adapted to silicon waveguides since the pumping of the active waveguide channels was conducted at 1480 nm where silicon shows great transparency.

### Example 2

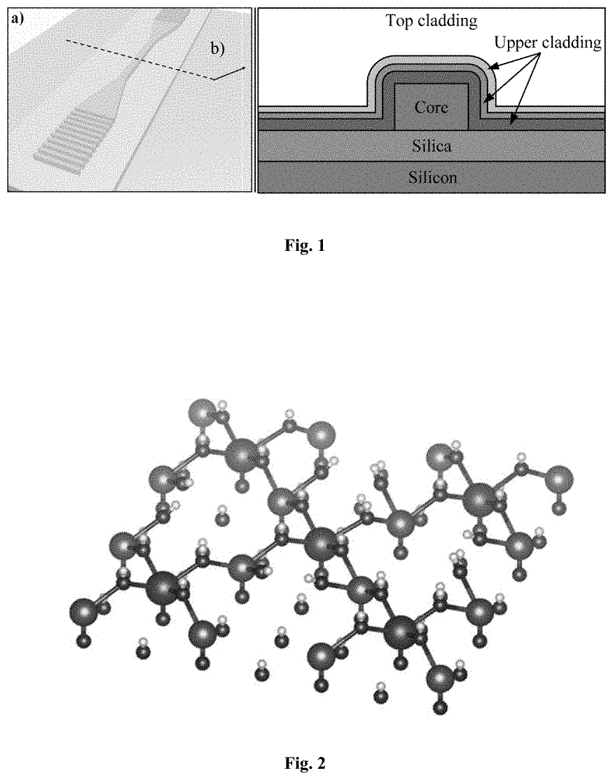

In this example, a multilayer waveguide amplifier design that combines a silicon nitride strip waveguide and multiple spatially engineered Er:Al₂O₃ gain layers is demonstrated. The cross-section of this device is illustrated in FIG. 1b. Five different Er:Al₂O₃ gain layers were fabricated on a silicon substrate and their spectroscopic properties were studied via photoluminescence (PL) characterization. With numerical simulations, these layers were utilized to design a waveguide amplifier with improved gain properties.

Characterization

The cycle sequences and the resulting film compositions of the erbium-alumina active layers prepared in Example 2 are presented in Table 3.

TABLE 3
Properties and preparation conditions for the atomic
layer-deposited erbium-alumina active layers

| | | | | | Elemental | | | |
|---|---|---|---|---|---|---|---|---|
| | | | | Thick- | composition | | | |
| | Number of cycles | | | ness | (at. %) | | | |
| Layer | Er₂O₃ | Al₂O₃ | Total | (nm) | O | Al | Er | Layer |
| 1 | 1 | 12 | 125 | 146.6 | 64.26 | 34.63 | 1.11 | 1 |
| 2 | 1 | 8 | 187 | 148.8 | 63.80 | 34.55 | 1.65 | 2 |
| 3 | 1 | 6 | 250 | 149.8 | 63.53 | 34.49 | 1.98 | 3 |
| 4 | 1 | 3 | 500 | 150.6 | 63.28 | 33.64 | 3.08 | 4 |
| 5 | 1 | 2 | 750 | 151.1 | 62.92 | 33.20 | 3.88 | 5 |

The gain layers were then post-process annealed at 800° C. for 20 minutes.

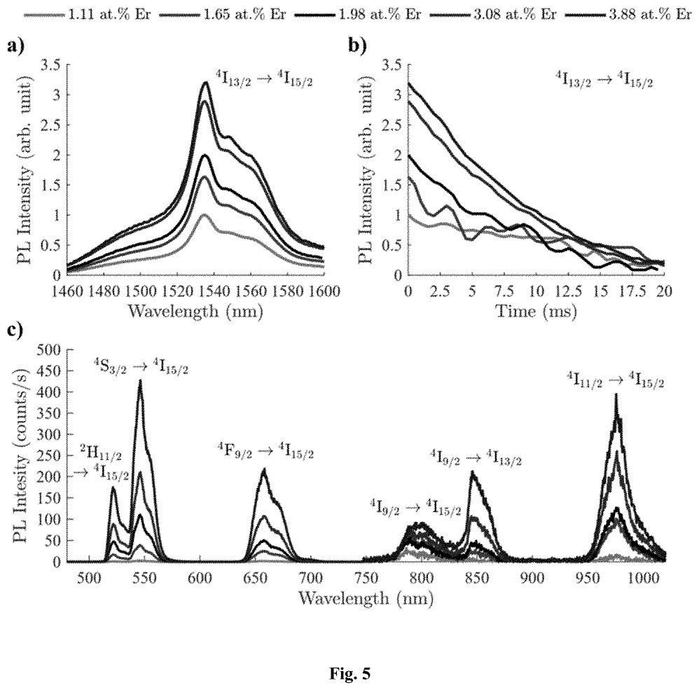

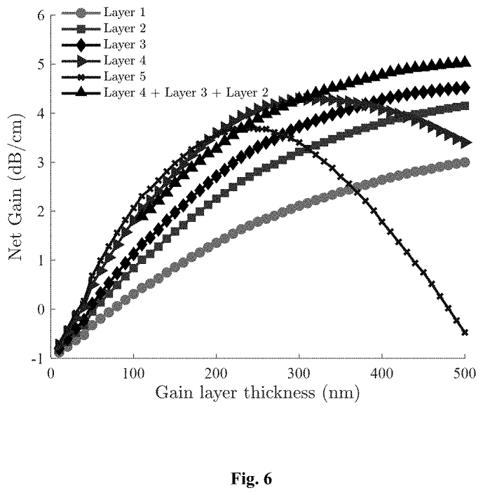

The erbium-alumina active layers were characterized by photoluminescence (PL) measurements. The PL characterization is shown in FIG. 5. FIG. 5a presents the PL responses of the erbium-alumina active layers at the wavelength range λ=1450-1600 nm. The measurements were performed with 532 nm excitation wavelength and 1.0 kW/cm³ excitation intensity. A characteristic ⁴I_{13/2}→⁴I_{15/2}, PL response peak at λ=1533 nm was measured for all the layers with the PL intensity increasing as the erbium concentration in the layer increased.

FIG. 5b shows PL responses of erbium-alumina layers at λ=1533 nm as a function of the measurement time in the absence of excitation. The measurements were performed by pumping the layers to steady-state with the same excitation conditions as in FIG. 5a and then turning off the excitation. Based on the results, all the layers exhibited exponential PL decay with the PL signal vanishing after approximately 20 ms. For layers 1-3, relatively small signal-to-noise levels were measured since lock-in amplifier could not be used in the time-dependent measurement.

FIG. 5c presents PL responses of the erbium-alumina layers at the wavelength range λ=480-1020 nm. The measurements were performed with 1480 nm excitation wavelength and 25 kW/cm³ excitation intensity. All characteristic transitions terminating at the ground state from the second excited state (⁴I_{11/2}→⁴I_{15/2}), third excited state (⁴I_{9/2}→⁴I_{15/2}), fourth excited state (⁴I_{9/2}→⁴I_{15/2}), fifth excited state (⁴I_{3/2}→⁴I_{15/2}) and sixth excited state (²I_{11/2}→⁴I_{15/2}) were detected with the PL intensity of each transition increasing as the erbium concentration in the layer increased. In addition, transition from the third excited state to the first excited state (⁴I_{9/2}→⁴I_{13/2}) was also detected.

Based on the PL measurements a further data analysis can be performed with a commonly known theoretical methods. PL measurement can be used for example to calculate the excited state lifetimes (τ₂) and the co-operative up-conversion coefficients (C₂₂, C₂₃, C₃₃) of the Er:Al₂O₃ layers. Some intrinsic material properties of the erbium-alumina active layers of Example 2 have been presented in table 4. Based on the data analysis it can be concluded that the critical quenching is not present in the layers.

Overall, it can be concluded that the Er:Al₂O₃ layers of the present invention exhibit excellent intrinsic material properties, i.e. long excited state lifetimes with no evidence of optical deactivation of the erbium ions, wherein the erbium-doped layers are suitable for high-performance optical amplification in the waveguide amplifier design that follows.

TABLE 4
Evaluated spectroscopic properties of the Er:Al2O3 gain layers

| | | τ₂N₀ × 10¹⁸ | C₂₂ × 10⁻¹⁸ | C₂₃ × 10⁻¹⁸ | C₃₃ × 10⁻¹⁸ |
|---|---|---|---|---|---|
| N₀ (at. 9/6) | τ₂₁ (ms) | (cm⁻³s) | (cm3s⁻¹) | (cm3s⁻¹) | (cm3s⁻¹) |
| 1.11 | 7.80 ± 0.40 | 8.66 ± 0.45 | 7.57 | 0.17 | 1.12 |
| 1.65 | 7.59 ± 0.27 | 12.52 ± 0.45 | 3.80 | 0.25 | 1.66 |
| 1.98 | 6.96 ± 0.20 | 13.58 ± 0.40 | 4.59 | 0.31 | 2.00 |
| 3.08 | 5.84 ± 0.02 | 17.98 ± 0.06 | 7.11 | 0.47 | 3.09 |
| 3.88 | 5.77 ± 0.01 | 22.39 ± 0.04 | 8.98 | 0.60 | 3.90 |

Based on the measured spectroscopic properties of the erbium-alumina layers, a multilayer waveguide amplifier was designed by spatially controlling the erbium-ion distribution of the proposed multilayer waveguide amplifier such that it matches the transverse intensity distribution of the fundamental mode propagating within the device. A waveguide with length of 1 cm was considered with an input signal power of 1 μW and wavelength of 1533 nm. With a commonly known theoretical methods, numerical gain characterization was performed. FIG. 5 shows the numerically evaluated net optical gain in six different gain layer configurations as a function of the gain layer thickness: 1) 10-500 nm of Layer 1 (1.11 at. % Er), 2) 10-500 nm of Layer 2 (1.65 at. % Er), 3) 10-500 nm of Layer 3 (1.98 at. % Er), 4) 10-500 nm of Layer 4 (3.08 at. % Er), 5) 10-500 nm of Layer 5 (3.88 at. % Er) and 6) 100 nm of Layer 4 (3.08 at. % Er), 200 nm of Layer 3 (1.98 at. % Er) and 200 nm of Layer 2 (1.65 at. % Er). As visible in FIG. 5, the spatially-controlled multilayer (Layer 4+Layer 3+Layer 2) gives the highest gain performance. Ultimately, the design, enabled by atomic layer deposition, opens up a completely new approach in developing silicon-integrated waveguide amplifiers with as high efficiency extracted from the active section as possible.

### INDUSTRIAL APPLICABILITY

The present waveguide amplifier and the waveguide amplifier device, as well as the method for producing those, can be used generally for replacement of conventional waveguide amplifiers and methods producing those.

In particular, the present waveguide amplifier is useful to be used as an infrared emitter that is both CMOS-compatible and efficient at the same time.

### CITATION LIST

US2003/0174391

U.S. Pat. No. 7,469,558

1. A strip waveguide amplifier comprising:
a silicon substrate;
an optical quality silicon dioxide (silica) layer formed on the substrate;
a silicon nitride layer formed on the silica layer; and
an erbium-doped aluminum oxide layer on the silica and the silicon nitride layers,
wherein the erbium-doped aluminum oxide layer is deposited by atomic layer deposition (ALD).

2. The strip waveguide amplifier according to claim 1, further comprising a resist layer formed on the erbium-doped aluminum oxide layer.

3. The strip waveguide according to claim 1, wherein in the erbium-doped aluminum oxide layer has an erbium doping concentration of 0.5 to 5 at. %, calculated from the number of total atoms in the erbium-doped aluminum oxide layer.

4. The strip waveguide amplifier according to claim 1, wherein the silica layer has a thickness of 1.0 to 2.0 μm, wherein the silicon nitride layer has a thickness of 400 to 800 nm, and wherein the erbium-doped aluminum oxide layer has a thickness of 100 to 200 nm.

5. (canceled)

6. (canceled)

7. The strip waveguide amplifier according to claim 1, wherein the erbium doping concentration is progressively controlled with the perpendicular plane to the surface of the erbium-doped aluminum oxide layer in nanometer scale, and within the planar and perpendicular plane to the surface of the erbium-doped aluminum oxide layer in atomic scale.

8. The strip waveguide amplifier according to claim 1, comprising a single active layer of erbium-doped aluminum oxide deposited by ALD.

9. A method for producing a strip waveguide amplifier comprising:
providing a silicon substrate;
depositing silicon dioxide on the silicon substrate to form a silica layer thereon;
depositing silicon nitride layer on the silica layer; and
coating the silica layer and the silicon nitride layer with an erbium-doped aluminum oxide layer deposited by atomic layer deposition (ALD).

10. The method according to claim 9, wherein the silica layer and the silicon nitride layer are deposited by using low-pressure and plasma-enhanced chemical vapor deposition, respectively, followed by a deep-ultraviolet lithography and reactive ion etching.

11. The method according to claim 9, wherein the ALD is performed by sequentially depositing erbium oxide and aluminum oxide.

12. The method according to claim 11, wherein the erbium oxide is grown by using Er(thd)₃ and ozone precursor, and aluminum oxide is grown by using trimethylaluminum and water precursor.

13. The method according to claim 9, wherein the temperature employed during ALD deposition is in the range of 250 to 350° C.

14. The method according to claim 9, wherein the produced waveguide amplifier is post-process annealed at 600 to 1000° C.

15. A strip waveguide amplifier device comprising multiple waveguide channels coated with an erbium-doped aluminum oxide layer, each channel containing one waveguide amplifier according to claim 1 followed by a grafting coupler and a multi-mode to single-mode transition taper at the input and output sides of the corresponding waveguide channel.

16. A waveguide amplifier comprising
a silicon substrate;
an optical quality silicon dioxide (silica) layer formed on the substrate;
a silicon nitride layer formed on the silica layer; and
a rare-earth material-doped aluminum oxide layer on the silica and the silicon nitride layers,
wherein the rare-earth material doped aluminum oxide layer is deposited by atomic layer deposition (ALD),
wherein the doping concentration of the rare-earth material is progressively decreased perpendicularly to the surface plane of the silicon substrate.

17. The waveguide amplifier according to claim 16, wherein the rare-earth material is comprises one or more lanthanides.

18. The waveguide amplifier according to claim 16, comprising a strip waveguide amplifier.

19. The waveguide amplifier according to claim 16 comprising a single active layer deposited by ALD.

20. A method for producing waveguide amplifier comprising:
providing a silicon substrate;
depositing silicon dioxide on the silicon substrate to form a silica layer thereon;
depositing silicon nitride layer on the silica layer; and
coating the silica layer and the silicon nitride layer with a rare-earth material-doped aluminum oxide layer deposited by atomic layer deposition (ALD),
wherein the doping concentration of the rare-earth material is progressively decreased perpendicularly to the plane of the substrate when moving away from the substrate.

21. The method according to claim 20, comprising producing a strip waveguide amplifier.

22. The strip waveguide amplifier according to claim 1, further comprising a resist layer of poly(methyl methacrylate) (PMMA) formed on the erbium-doped aluminum oxide layer.
